(19) United States
(12) Patent Application Publication
(10) Pub. No.: US 2002/0034971 A1
(43) Pub. Date: Mar. 21, 2002

(54) DATA ALLOCATION FOR MULTIPLE APPLICATIONS ON A MICROPROCESSOR OR DSP

(76) Inventors: CHIENCHUNG CHANG, SAN DIEGO, CA (US); SAMIR GUPTA, SAN DIEGO, CA (US); WAY-SHING LEE, SAN DIEGO, CA (US); GAOZHI PAN, SAN DIEGO, CA (US)

Correspondence Address: Qualcomm Incorporated, Patents Department, 5775 Morehouse Drive, San Diego, CA, 92121-1714, US

(21) Appl. No.: 09/247,000

(22) Filed: Feb. 8, 1999

(51) Int. Cl. H04M 1/00

(52) U.S. Cl. 455/569; 455/74.1

(57) ABSTRACT

The present invention is a novel and improved method and apparatus for performing multiple applications on a microprocessor or DSP. One embodiment of the invention includes a car kit for interfacing with a cellular telephone. The care kit includes a digital signal processor for performing digital signal processing and a cradle unit for holding the cellular telephone and for providing a link to said digital signal processor. Additionally, an on-chip memory is provided, located on an integrated circuit with the digital signal processor, for storing a limited function program that control said DSP. Off-chip memory stores multiple limited function programs and for loading any one of the limited function programs to the on-chip memory.

### BACKGROUND OF THE INVENTION

I. Field of the Invention

The present invention relates to signal processing. More particularly, the present invention relates to switching application programs and swapping data without the use of an extra “garbage” sector in the external memory.

II. Description of the Related Art

Digital signal processors (DSPs) are well suited for performing computationally intensive applications. Examples of computationally intensive applications include voice recognition, speech synthesis, acoustic echo canceling, and noise suppression. Typically, each function is performed by applying a set of code instructions (i.e. a program) to the DSP.

Within environments such as cellular (wireless) telephony, a DSP typically has to perform many of the above mentioned functions, as well as other functions, in a rapidly interchangeable fashion. The present invention is directed to facilitating the use of a DSP to perform multiple functions, including the various functions performed by a DSP when used in a wireless communications environment.

A DSP usually has a relatively limited size of on-chip memory. The on-chip memory is typically used as both program and data memory. This limited on-chip memory make it impractical, if not impossible, to load all application programs and data tables into the on-chip memory at once. Thus, an efficient and reliable switching scheme is required to ensure the right application program and data can be downloaded from external memory to internal DSP memory to perform desired functions.

However, when data in the external memory needs to be modified, the largest sector is usually reserved as a garbage sector to swap the data in the embodiment when flash memory is used as external memory. This garbage sector is generally an inefficient use of external memory.

### SUMMARY OF THE INVENTION

The present invention is a novel and improved method and apparatus for performing multiple applications on a microprocessor or DSP. One embodiment of the invention includes a car kit for interfacing with a cellular telephone. The care kit includes a digital signal processor for performing digital signal processing and a cradle unit for holding the cellular telephone and for providing a link to said digital signal processor. Additionally, an on-chip memory is provided, located on an integrated circuit with the digital signal processor, for storing a limited function program that control said DSP. Off-chip memory stores multiple limited function programs and for loading any one of the limited function programs to the on-chip memory.

### BRIEF DESCRIPTION OF THE DRAWINGS

The features, objects, and advantages of the present invention will become more apparent from the detailed description set forth below when taken in conjunction with the drawing(s) in which like reference characters identify correspondingly throughout and wherein:

FIG. 1 is a block diagram of the wireless phone and hands free kits when configured in accordance with one embodiment of the invention;

FIG. 2 is a flow chart illustrating the operation of one embodiment of the invention;

FIG. 3 is a diagram of the external memory in an exemplary configuration;

FIG. 4 is flow chart illustrating a first procedure performed in accordance with one embodiment of the invention; and

FIG. 5 is flow chart illustrating a second procedure performed in accordance with one embodiment of the invention.

### DETAILED DESCRIPTION OF THE PREFERRED EMBODIMENTS

A method and apparatus for performing multiple applications on a microprocessor or DSP is described. The invention is described in the context of a hands free car kit used with a cellular telephone. Many aspects of the described embodiment provide utility within the context of such a hands free care kit. However, those skilled in the art will recognize the invention has application in other environments, configured either as the described embodiment, or as alternative embodiments. Additionally, when not specified, the various steps and information processing described herein may be performed and represented using electrical circuits and electromagnetic signals, or some derivation thereof.

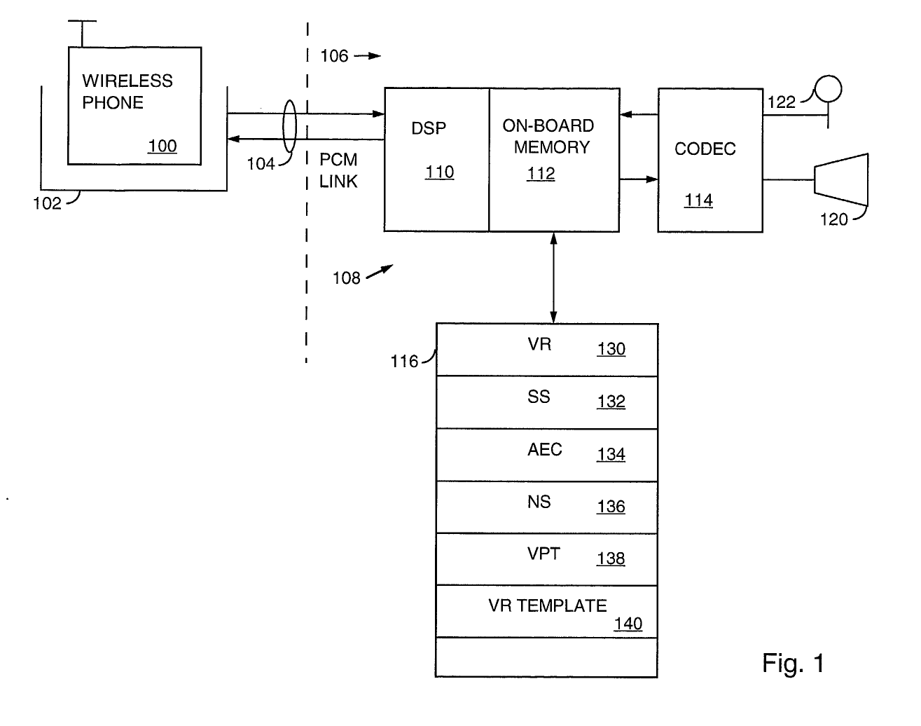

FIG. 1 is highly simplified a block diagram of the wireless phone and hands free kits when configured in accordance with one embodiment of the invention. Wireless phone 100 is placed in cradle 102. An electrical link 104 couples wireless phone 100 to hands free car kit 106, which is shown to the right of the dashed line. Within hands free car kit 106, DSP 108 includes core 110 and on-chip memory 112. DSP 108 is coupled to codec 114 and to off-chip memory 116. Off-chip memory 116 is preferably flash memory which stores data even when power is not applied.

During operation, wireless phone 100 and hands free car kit 106 exchange PCM signals. The signal typically represent voice information and control information, but may include a variety of information types including tones. Examples of the type of voice and control information transmitted are provided in U.S. patent application Ser. No. , entitled “COMMUNICATION PROTOCOL BETWEEN A COMMUNICATION DEVICE AND AN EXTERNAL ACCESSORY” filed and incorporated herein by reference.

In other instances, DSP 106 sends PCM data to codec 114. For example, when the voice interaction feature is activated, hands free care kit 106 may download the vocoder-based speech synthesis packets from off-chip memory 116, run speech synthesizer programs and send synthesized voice, such a voice queues or prompts, to codec 114. Codec 114 then causes speaker 120 to play synthesized voice so that the user can hear the prompts. Exemplary voice prompts include “input number,” indicating that a number should be input, or “calling Dave,” indicating that a call is being made to someone named Dave.

In other instances, codec 114 sends PCM data to DSP 106. For example, the user many say commands such as “Dial 543-7654,” which causes commands to be sent to wireless phone 100 that dial the number spoken. Similarly, the user may say the command “store Dave 453-5533,” which causes commands to be sent to wireless phone 100 that store the number under the name Dave. Additionally, wireless phone 100 and hands free car kit 106 may exchange PCM signals during a typical phone call, where speaker 120 and microphone 122 allow the call to be conducted using a speakerphone system. It should be apparent that other situations and functions may cause PCM data to be transmitted between wireless phone 100 and hands free kit 106.

In accordance with the function being performed by hands free car kit 106, which is often affected by the type of data being exchanged with wireless phone 100, hands free kit 106 must configure itself to conduct various operations. In one embodiment of the invention, the configuration is performed by loading limited function programs from into on-chip memory 112 from off-chip memory 116. Once loaded, these limited function programs control the operation of DSP 108 and cause various functions to be performed.

In one embodiment of the invention, various limited function programs are stored within off-chip memory 116. These limited function programs include, for example, voice recognition (VR) program 130, speech synthesizer program (SS) 132, acoustic echo canceller (AEC) 134, and noise suppressor 136. Additionally, off-chip memory 116 contains data files used by DSP 108 to perform the various functions. These data files include, for example, VPT? 140 and voice recognition (VR) template 142. VR template typically contains voice samples of command words used to determine received speech commands.

In the exemplary embodiment, off-chip memory is flash memory that keeps data stored when power is removed. The flash memory is divided into a number of sectors which must be completely rewritten in order to change. In the described embodiment, the sectors are configured as shown, with some sectors being as large as 64 Kbytes and other sectors having 32, 16 or 8 Kbytes.

When operating, the various limited function programs are loaded into the on-chip memory 112. For example, when a call begins, the acoustic echo canceller 134 is loaded along with the noise suppressor 136 to allow the call to proceed.

Once the call is complete, the voice recognition and speech synthesizer programs may be loaded overwriting the acoustic echo canceller and noise suppressor programs. By loading limited function programs only when they are in use, the size of on-chip memory can be reduced, thereby reducing the size of DSP 108 as well, reducing the cost of the DSP. Additionally, multiple function can be performed using the same DSP.

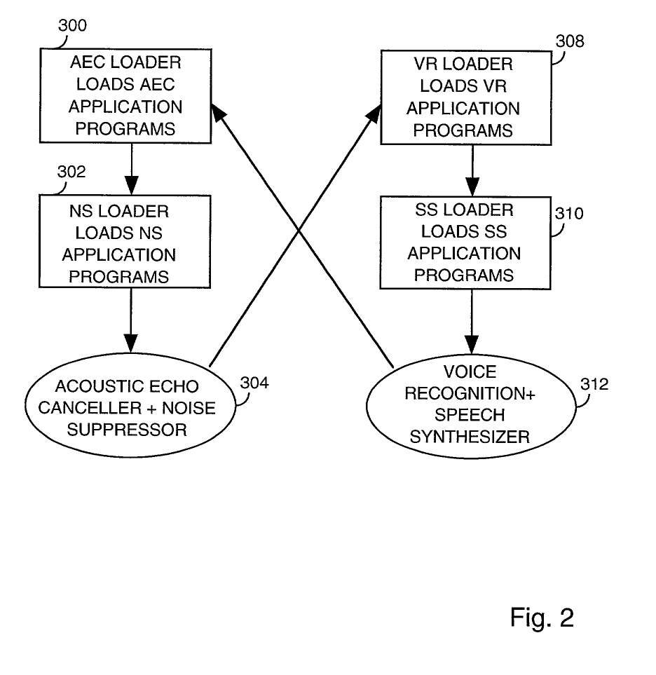

FIG. 2 is a flow chart illustrating the operation of the hand free kit in accordance with one embodiment of the invention. There are two operational modes for the hands free kit. One is VR mode 312 when both VR and SS application programs are loaded from off-chip memory 116 into on-chip memory 112; the other is AEC mode 304 when both AEC and NS application programs are loaded accordingly. The loader programs comprise the top level program which will not be overwritten when DSP switches its operational modes.

To switch from AEC mode 304 to VR mode 312, the VR loader loads the VR application programs at step 308, and the SS loader loads the SS application program at step 310. The programs are loaded into on-chip memory 112. To switch from VR mode 312 to AEC mode 304, the AEC loader load the AEC application program at step 300 and the NS loader loads the NS application program at step 302.

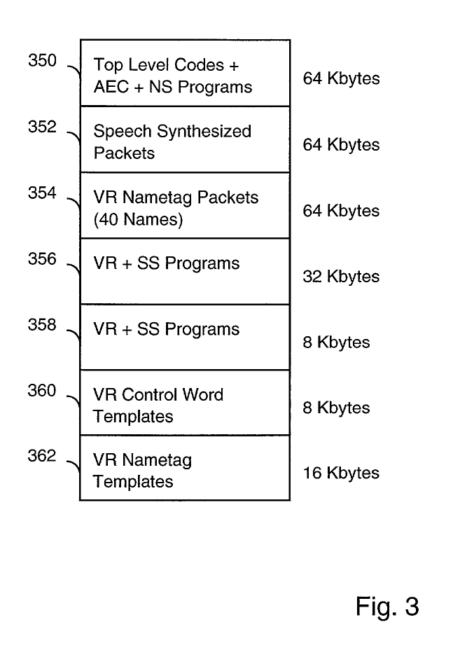

FIG. 3 is a diagram illustrating an exemplary configuration of the off-chip memory 116. Sector 350, contains top level codes, the AEC and the NS programs. Sector 352 contains the speech synthesized packets. Section 354 contains the VR nametag packets. These are the voice representations of the 40 names for which telephone numbers have been stored. Section 356 contains the first portion of the VR and SS programs and section 358 contains the second portion of the VR and SS programs. Section 360 contains the VR control word templates and Section 362 contains the VR nametag templates. The VR nametag templates include the status of the particular name, pointers to the nametag packets in section 354 and the telephone number.

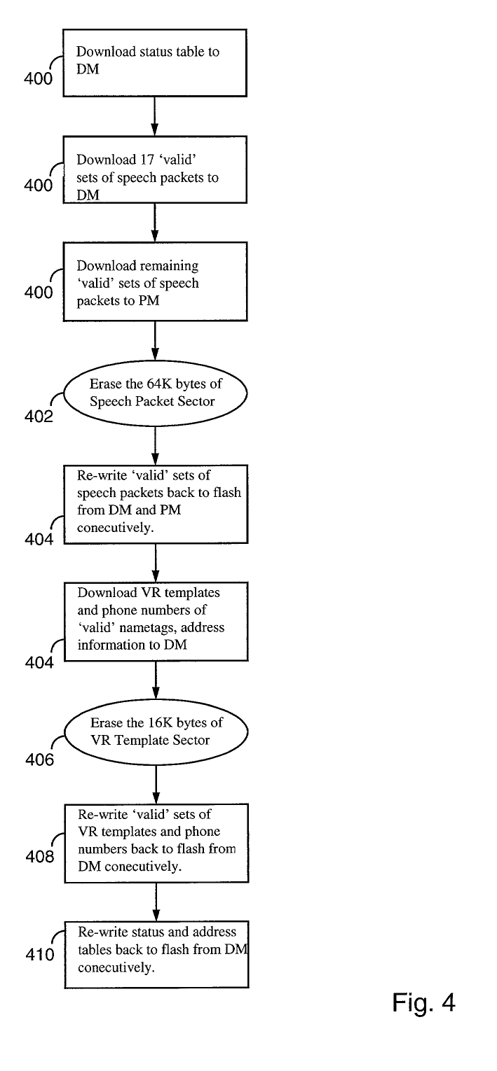

FIGS. 4 provides a flow chart demonstrating the procedure of swapping the data from external memory to on-chip DSP memory in accordance with one embodiment of the invention. The exemplary processing is provided in the context of a 64 Kbytes VR Nametag Packet being re-organized.

At step 400, the status table portion of the VR nametag template (sector 362) is down loaded to the data memory (DM) portion of the on-chip memory 112. The status portion includes indicator information for each nametag that may be set to “Valid,” “Unused” or “Delete” states.

As noted above, up to 40 sets of nametag packets can be stored in flash sector 354. The status table with 40 entries is saved in 16 Kbytes flash sector 362 and used to keep track of the status of each nametag stored in VR Nametag Packet sector.

To add a new nametag entry it is first determined if unused space available based on status table. If there is unused space, the recorded nametag packets will be saved sequentially into the available space in VR Nametag Packet sector and the corresponding status is changed from ‘Unused’ to ‘Valid’ in status table.

To delete a nametag, the corresponding status will be changed from ‘Valid’ to ‘Delete’ in status table while the corresponding nametag packets are not physically removed. The status table is designed in such a way that no flash sector erasure is required when change of status is needed.

Whenever DSP discovers there exists no ‘Unused’ space in the table and at least one ‘Delete’ records, a re-organization operation is performed. The reorganization operation requires both the VR Nametag Packet (64 Kbytes) and VR Nametag Template (16 Kbytes) sectors by modified.

FIG. 4 illustrates the steps performed during a reorganization operation. To delete the nametags physically from flash memory, the status table is first downloaded and examined at step 400. Based on that information, the DSP downloads the vocoder packets of ‘valid’ nametags from the 64 Kbyte sector 354 into both data and program memories.

For a DSP that only has a total of 80K bytes of on-chip memory, the first 17 ‘valid’ sets of speech packets are downloaded into data memory (DM) at step 402. The remaining ‘valid’ sets of speech packet are then downloaded into program memory (PM) at step 404. After downloading all ‘valid’ sets of speech packets corresponding to valid nametags, DSP will erase the 64K byte sector of flash memory at step 406. At step 408, the valid speech packets are written back to this 64K byte sector at consecutive locations at step 410.

Then the DSP will download VR templates and phone numbers of ‘valid’ nametags, status table of name record and address information from VR Nametag Template (16 Kbytes) sector at step 412. It will update the status table and address information accordingly. At step 414, the DSP then erases the 16K byte flash sector. At steps 416 and 418 it writes VR templates, phone numbers, status table and address information back to flash memory in the consecutive locations.

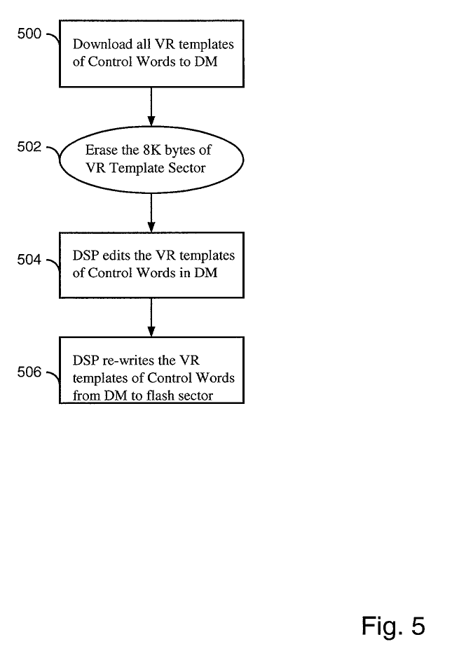

FIG. 5 illustrates the processing associated with performing retraining for a VR control word. To perform retraining the VR Control Word Template (8 Kbytes) sector needs to be updated with the new VR templates.

At step 500, all VR templates of the control words are downloaded to the DM. At step 502 the flash sector 360 is erased. At step 504, the DSP edits the data in on-chip memory 112 by replacing the old VR templates with new ones. At step 506 the edited version of VR templates is written back to 8K flash sector 360.

In the data swapping scheme mentioned above, DSP uses its on-chip memory, both data and program memories, to avoid incurring a garbage sector. A garbage sector of the size of 64 Kbytes would be required if the current data swapping scheme is not used. In other words, additional space of off-chip nonvolatile memory, or flash memory in the exemplary embodiment, becomes available. On the other hand, the data swapping speed is greatly improved due to the efficient usage of DSP on-chip memory.

Thus, a method and apparatus for performing multiple applications on a microprocessor or DSP is described. The previous description of the preferred embodiments is provided to enable any person skilled in the art to make or use the present invention. The various modifications to these embodiments will be readily apparent to those skilled in the art, and the generic principles defined herein may be applied to other embodiments without the use of the inventive faculty. Thus, the present invention is not intended to be limited to the embodiments shown herein but is to be accorded the widest scope consistent with the principles and novel features disclosed herein.

We claim:

1. A system for performing multiple signal processing functions comprising:
digital signal processor for performing signal processing operations;
on-chip memory, located on an integrated circuit with said digital signal processor, for storing a limited function program that control said DSP;
off-chip memory for storing multiple limited function programs and for loading any one of said limited function programs to said on-chip memory, wherein
said off-chip memory contains a status table listing the status of a set of nametag entries.

2. The system as set forth in claim 1 wherein said off chip memory is divided into section, and each section contains on limited function program.

3. The system as set forth in claim 2 wherein each section must be read from and written to in its entirety.

4. A car kit for interfacing with a cellular telephone comprising:
digital signal processor for performing digital signal processing;
cradle unit for holding the cellular telephone and for providing a link to said digital signal processor;
on-chip memory, located on an integrated circuit with said digital signal processor, for storing a limited function program that control said DSP;
off-chip memory for storing multiple limited function programs and for loading any one of said limited function programs to said on-chip memory.

5. The car kit as set forth in claim 4 wherein said link is a pulse coded modulation link.

6. The car kit as set forth in claim 4 wherein said off chip memory is divided into sections, and each section contains on limited function program.

7. The system as set forth in claim 6 wherein each section must be read from and written to in its entirety.

8. A method for maintaining a database of nametag packets comprising the steps of:
a) setting a status record of a first packet to invalid when said packet is deleted;
b) reading out valid packets when no nametag packet space is available;
c) erasing a sector containing valid and invalid nametag packets;
d) writing valid packets into said sector.
